(19) United States
(12) Patent Application Publication
(10) Pub. No.: US 2001/0048902 A1
(43) Pub. Date: Dec. 6, 2001

(54) Treatment system for removing hazardous substances from a semiconductor process waste gas stream

(76) Inventors: Christopher Hertzler, San Jose, CA (US); Christopher Latam, San Jose, CA (US); David Korn, Scotts Valley, CA (US)

Correspondence Address: CARR & FERRELL LLP, 2225 EAST BAYSHORE ROAD, SUITE 200, PALO ALTO, CA, 94303, US

(21) Appl. No.: 09/846,495

(22) Filed: Apr. 30, 2001

Related U.S. Application Data
(60) Provisional application No. 60/200,959, filed on May 1, 2000.

(51) Int. Cl. B01D 50/00

(52) U.S. Cl. 422/177

(57) ABSTRACT

A system for controlling emissions of hazardous, toxic or otherwise undesirable components in a waste gas stream, while maintaining uptime through decreased maintenance and repair, is provided. The system oxidizes the waste gas stream at high temperatures with a thermal oxidizer (110), effectively removes particulates in the waste gas stream as well as moderate levels of acid gas through a cyclone scrubber (120), and removes the remainder of the acid gas content in the waste gas stream through he use of a packed column (130). Finally, a condenser (140) lowers the moisture content of the waste gas stream before leaving the system by way of a blower (150), reducing the chance of condensation and corrosion in the facility ductwork. As a result, the system can run for sustained periods of time, reducing downtime in semiconductor operations and associated loss of revenue.

### CROSS-REFERENCES TO RELATED APPLICATIONS

This application claims the benefit of Provisional Patent Application Serial No. 60/200,959, filed on May 1, 2000, entitled “Treatment System For Removing Hazardous Substances From A Semiconductor Process Waste Gas Stream,” which is incorporated herein by reference.

### BACKGROUND OF THE INVENTION

1. Field of the Invention

The present invention relates to waste gas treatment systems, and more particularly to a system and method for reducing or eliminating emissions of toxic or dangerous gases and particulate matter.

2. Description of Related Art

Semiconductor fabrication processes, such as chemical vapor deposition (CVD), utilize several chemicals that are highly toxic, corrosive, flammable, pyrophoric or otherwise dangerous. Typically, the process consumes only small portions of the chemicals. The unconsumed chemicals, together with particulate-phase reaction products, exit the processing equipment as a waste gas stream and flow into an exhaust system. Because certain components of the waste gas stream possess dangerous or noxious properties, it is desirable and/or legally required to treat the waste gas stream prior to discharge to the atmosphere in order to eliminate or minimize discharge of the objectionable waste gas components.

The prior art includes a number of commercially available waste gas treatment systems for removing selected gas- and solid-phase substances from the waste gas stream. Because of the relatively high particulate loading and corrosive nature of the waste gas stream, users of prior art treatment systems often experience problems with clogging of the gas flow path and component wear. Remediation of these problems (e.g., removal of accumulated particulate matter or replacement of corroded components) frequently necessitates temporary shutdown of the associated process equipment, causing unscheduled downtime. Such unscheduled downtime increases overall manufacturing costs and thus is particularly problematic in the highly competitive and price-driven semiconductor fabrication industry. Users of prior art treatment systems therefore find themselves forced to choose between a trade-off of downtime versus abatement efficiency.

In view of the foregoing discussion, there is a need for a waste gas treatment system which avoids the clogging and corrosion problems which lead to unscheduled downtime, while efficiently and effectively reducing concentrations of hazardous or toxic substances in the waste gas stream to acceptable levels.

### SUMMARY OF THE INVENTION

In accordance with an aspect of the present invention, a system is provided for controlling emissions of hazardous, toxic or otherwise undesirable components in a waste gas stream, while maintaining uptime through decreased maintenance and repair.

The system incorporates a highly effective technique for destroying selected gaseous species in the waste stream. By oxidizing the waste gas stream at high temperatures, combustible substances contained in the waste gas are removed. The gas then passes through a cyclone scrubber, which effectively removes particulates in the waste gas stream as well as moderate levels of acid gas, and is the principal heat removal device in the system. The waste gas then passes through a counter flow type packed column, which removes the remainder of the acid gas. Finally, the waste gas stream is passed through a condenser to lower the moisture content of the gas before it leaves the system by way of a blower.

The system advantageously includes a means for reducing the accumulation of particulates on internal surfaces of the treatment system, thereby avoiding the clogging problems associated with prior art systems. The cyclone scrubber utilizes a wetting means to prevent adherence of particulate matter to the internal components of the system. Additionally, the reduced moisture in the waste gas caused by the condenser reduces the chance of condensation and corrosion in the facility ductwork.

As a result of the foregoing improvements, the system effectively removes dangerous and noxious substances from the waste gas and can run for sustained periods of time, thereby reducing downtime in semiconductor operations and associated loss of revenue. The system is particularly well suited to abatement in semiconductor fabrication processes such as CVD.

### BRIEF DESCRIPTION OF THE DRAWINGS

FIG. 1 schematically depicts a waste gas treatment system according to the present invention.

FIG. 2A depicts a side view of a cyclone scrubber used in the waste gas treatment system of FIG. 1.

FIG. 2B depicts a top view of the cyclone scrubber used in the waste gas treatment system of FIG. 1.

FIG. 3 depicts a top view and three side views of an inner tube of the cyclone scrubber of FIGS. 2A and 2B.

FIG. 4 depicts a packed column component of the waste gas treatment system of FIG. 1.

### DESCRIPTION OF THE PREFERRED EMBODIMENT

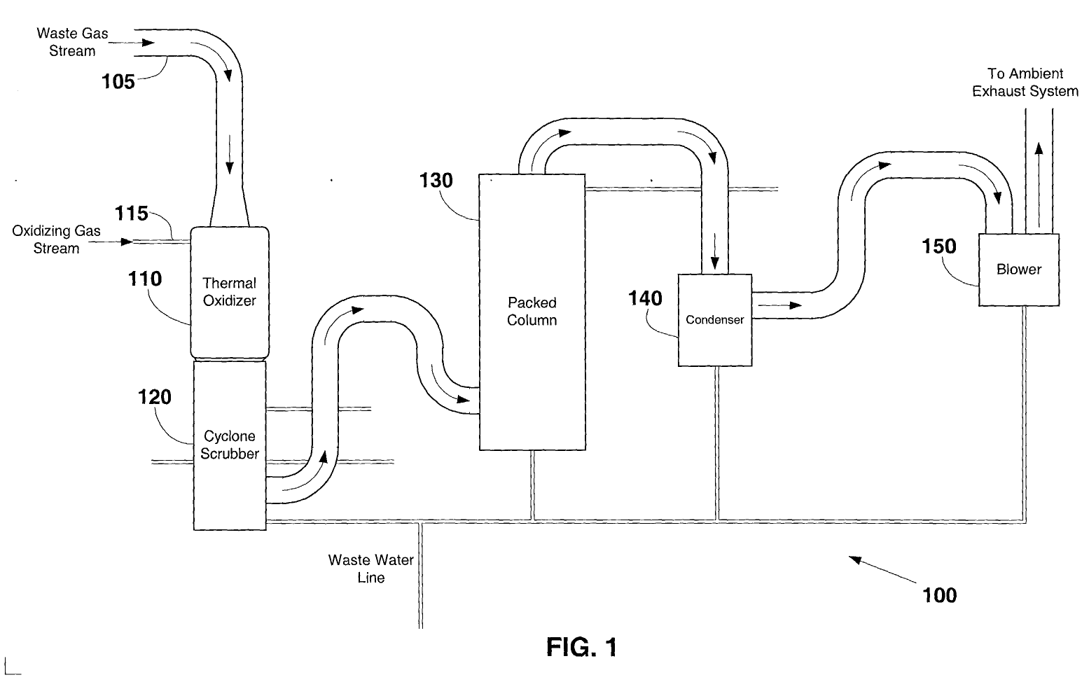

FIG. 1 schematically depicts a waste gas treatment system 100 constructed in accordance with one aspect of the present invention. The waste gas treatment system 100 is seen to generally include a thermal oxidizer 110 for oxidizing selected gas-phase species, a cyclone scrubber 120 for removing particulate matter and a portion of the acid gases, a packed column 130 for removing remaining acid gases, a condenser 140 for removing a portion of the water vapor, and a blower 150 for drawing the waste gas stream through treatment system 100.

A waste gas stream from a semiconductor fabrication process tool, such as a nitride process tool, flows initially to the thermal oxidizer 110 by way of a waste gas inlet 105. In a typical implementation of the treatment system 100, the waste gas stream emitted by the process tool will include a nitrogen or other inert gas carrier mixed with various gas-phase and particulate-phase components which must be removed or destroyed prior to release of the waste gas stream to an ambient exhaust system. Typical gas-phase components that must be abated include silane (SiH₄), ammonia (NH₃), flourine, and hydrogen fluoride (HF). Particulate-phase components of the waste gas stream may include silicon nitride (SiN), silicon dioxide (SiO₂), and tungsten hexafluoride (WF₆). During normal operation of the process tool, the waste gas stream will be periodically alternated with a clean gas stream, typically comprising nitrogen trifluoride (NF₃) or a Freon compound.

At the thermal oxidizer 110, the waste gas stream is mixed with an oxidizing gas stream, which is injected by way of oxidizing gas inlet 115, and passed through a high-temperature reaction zone inside the thermal oxidizer 110. The oxidizing gas stream, which will typically include air or an air/oxygen mix, is injected into the waste gas stream through the oxidizing gas inlet 115 at high pressure in order to induce turbulence and promote rapid mixing of the streams inside the thermal oxidizer 110. The amount ofoxidizing gas added to the waste gas stream may be adjusted according to the composition of the waste gas and abatement requirements. The thermal oxidizer 110 includes a heated metal tube through which the mixed gas streams are passed. The tube is fabricated from a commercially available high-temperature alloy such as Inconel 600 or Hastelloy C22. The tube may be heated with a conventional radiative ceramic resistance heater or suitable alternative. Depending on the waste gas stream composition and abatement requirements, the tube surface is heated to a temperature of between 500° C. and 850° C. The tube dimensions are preferably selected to provide adequate reaction time for oxidation of silane and other toxic gaseous species to be substantially completed, while maintaining gas velocity sufficiently high to minimize deposition of particulates on the tube's inner wall.

The waste gas stream then exits the thermal oxidizer 110 and is directed into the cyclone scrubber 120. As mentioned above, the cyclone scrubber 120 is operative to remove particulate-phase components of the waste gas stream along with a portion of the highly water-soluble gas-phase components such as hydrogen fluoride. The cyclone scrubber 120 has an additional function of cooling the waste gas stream, which is heated to an elevated temperature inside the thermal oxidizer 110. It has been observed that accumulation of particulate matter tends to occur at or proximal to the interface between the dry and wet zones of the cyclone scrubber 120, unless at least one of two conditions is met: (1) surface temperature exceeds 300° C., or (2) the surface is coated with water.

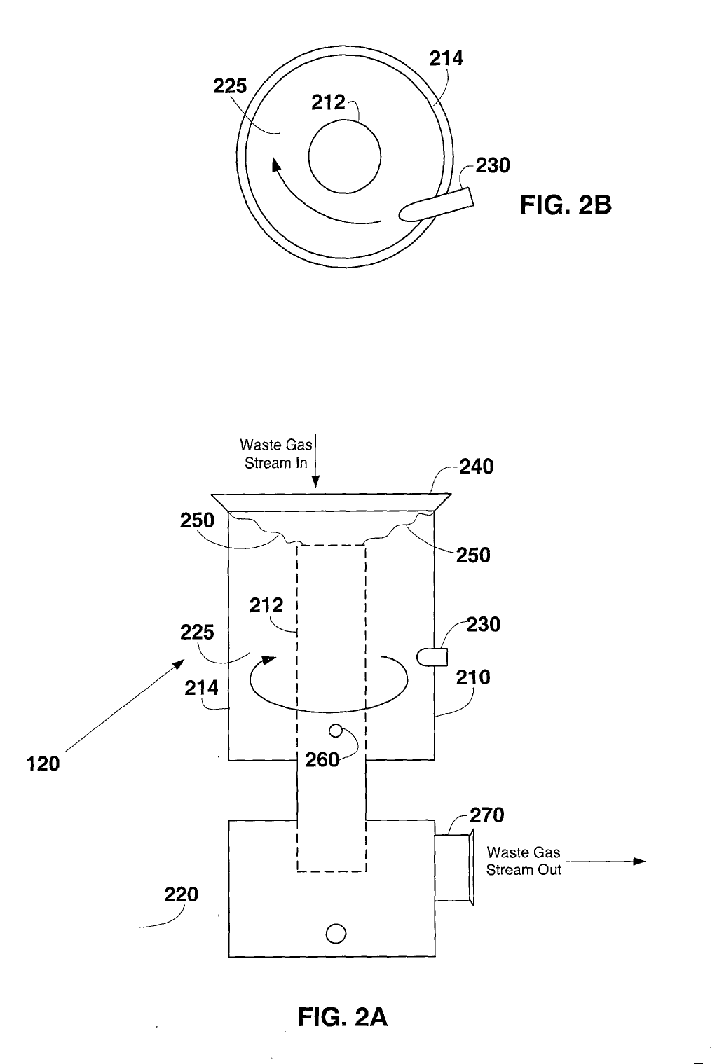

The features and operation of cyclone scrubber 120 may best be understood with reference to FIGS. 2A and 2B, which respectively depict side and top views thereof. As can be seen in FIG. 2A, the cyclone scrubber 120 includes an upper section 210 and a lower section 220. The upper section 210 is constructed from an inner tube 212, through which the waste gas stream flows, and an outer tube 214 having a substantially larger diameter than the inner tube 212 and being positioned generally coaxially therewith. An annulus 225 is defined in the space between the inner and outer tubes 212 and 214, into which water is injected through an injection port 230 that extends through the wall of outer tube 214. As may be seen with reference to FIG. 2B, the longitudinal axis of the injection port 230 is angularly offset with respect to the radial axis of tubes 212 and 214 so as to impart a swirling or rotational movement to the water contained in the annulus 225, the purpose of which is discussed below. Referring again to FIG. 2A, the upper end of the outer tube 214 is provided with a flange 240 which mates with a corresponding flange located at the lower end of the thermal oxidizer 110 (FIG. 1). As can be seen, the upper end of the inner tube 212 is positioned slightly lower (about 1″ in the implementation depicted) than the upper end of the outer tube 214. Water injected through injection port 230 rises up in the annulus 225 until reaching the upper end of the inner tube 212. The annulus 225 continues to fill with water until the water spills over the upper end and flows down the inner wall of inner tube 212. The water film coating the surface of the inner wall acts to prevent accumulation of particulate matter and eventual clogging of the gas flow path.

The swirling motion imparted to the water by the angular positioning of the injection port 230 serves to ensure that all surfaces contacted by the waste gas stream within the cyclone scrubber 120 are wetted. In the absence of the swirling motion of the water within the annulus 225, the upper margins of the outer tube 214 (which, as explained above, extends about 1″ above the upper end of the inner tube 212) would not be coated with water, and hence accumulation of particulate matter thereon would occur. By imparting a swirling motion to the water, a free surface 250 of the water is given a conical aspect (as indicated on FIG. 2A) owing to the higher velocity of the water at the outer radius relative to the water velocity at the inner radius of the annulus 225. The water in the annulus 225 thus extends further upwardly along the surface of the outer tube 214 (to the bottom of the flange 240) such that all gas-contacted surfaces within the cyclone scrubber 120 are wetted. Because the waste gas stream passes immediately from the thermal oxidizer 110 (FIG. 1), wherein all gas-contacted surfaces are maintained at high temperature, to the cyclone scrubber 120, wherein all gas-contacted surfaces are wetted, particulate deposition is minimized and clogging problems are avoided.

The inner tube 212 extends downwardly into the lower section 220 of the cyclone scrubber 120. As the waste gas stream passes through the inner tube 212 into the lower section 220, water is injected into the waste gas stream near the entrance of the lower section 220 through one or more water spray inlets 260.

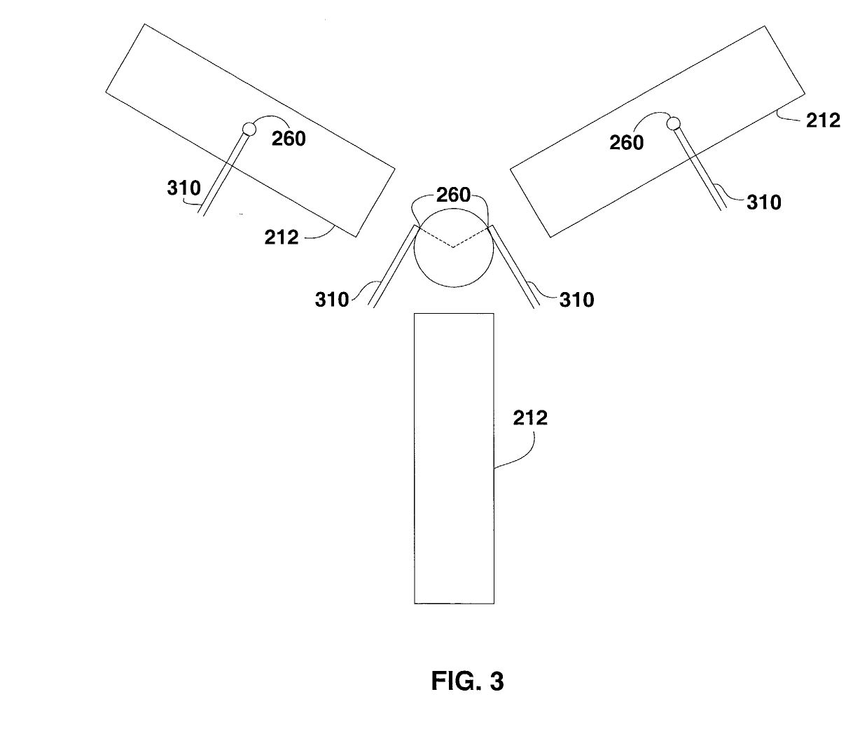

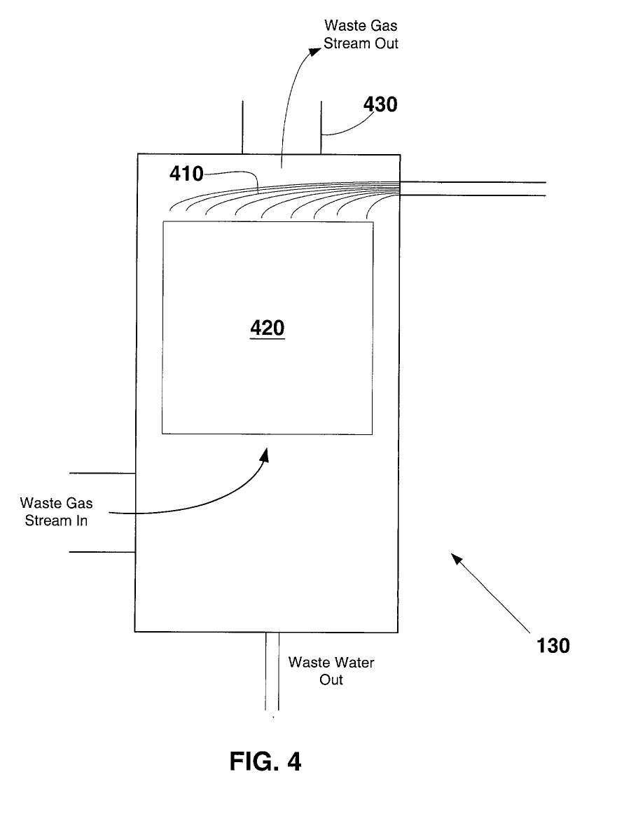

FIG. 3 depicts a top view and three side views of the inner tube 212. As can be seen, the water spray inlets 260 are coupled to one or more spray atomizers 310. The water spray inlets 260 and the spray atomizers 310 are preferably positioned on the inner tube 212 so as to prevent the water droplets emitted from the spray atomizers 310 from traveling upward into the thermal oxidizer 110, which would cool the gas-contacted surfaces and cause accumulation of particulate material. As is known in the art, the water droplets injected into the waste gas stream by the spray atomizers 310 in this way contact and capture particulates in the waste gas stream. Alternatively, the spray atomizers 310 can inject recycled water from the packed column 130 into the waste gas stream, as will be explained below in reference to FIG. 4.

The water droplets injected into the cyclone scrubber 120 also serve to absorb a portion of the highly water-soluble acid gas species (such as hydrogen fluoride) from the waste gas stream, forming particle-laden droplets. Referring back to FIG. 2A, the particulate-laden droplets, together with the water used to wet the inner tube 212 and the outer tube 214, travel downwardly under the influence of gravity and are collected in a reservoir for further processing. The waste gas stream is then turned upwardly, exits the cyclone scrubber 120 via a side port 270, and is passed to the packed column 130 (FIG. 1). The risk of fouling the packing of the packed column 130 is greatly reduced by removing particulate matter from the waste gas stream at the cyclone scrubber 120.

Referring to FIG. 4, the waste gas stream is directed to the packed column 130 for removal of the remaining acid gases and particulate matter. The packed column 130 is preferably of the counterflow type, wherein a water spray 410 is introduced at the upper end of the packed column 130 and travels downwardly, while the waste gas stream is introduced proximal the lower end of the packed column 130 and flows upwardly. A packing material 420 is utilized in the packed column 130. In one aspect, the packing material includes alumina ceramic, because of its superior qualities of removing flourine gas. In other aspects, the packing material includes stainless steel, Teflon, and polypropylene. As the water flows downwardly through the packing material, it absorbs the remaining acid gases (typically hydrogen fluoride) in the waste gas stream, together with any particulate matter not captured in the cyclone scrubber 120. The resultant acidic wastewater is thereafter collected and can be processed or alternatively used to provide water to the spray atomizers 310 as described in reference to FIG. 3. The advantage of using the wastewater from the packed column 130 in the spray atomizers 310 is that the acid gases (typically hydrogen fluoride) contained in the wastewater substantially eliminates the presence of such corrosives as silicon nitride from the system, further enhancing the anti-clogging benefits and uptime of the system. After processing by the packed column 130, the waste gas stream exits through an exit duct 430 located at the upper end thereof.

Referring back to FIG. 1, the waste gas stream leaving the packed column 130 flows to the condenser 140. The condenser 140 is operative to reduce the water vapor concentration in the waste gas stream in order to prevent or minimize the occurrence of condensation in facility ductwork, which may lead to corrosion problems. The condenser 140 also serves as a water trap to prevent moisture from the packed column 130 from entering the blower 150. The condenser 140 may be of any suitable design having cooled surfaces which contact the waste gas stream to cause water vapor to condense thereon, but will typically include thermally conductive tubing through which relatively cool water is circulated, the tubing having its outer surface contacting the waste gas stream. The condensed water is collected in the bottom of the condenser 140 and is removed via a drain line.

The waste gas stream (having a substantially reduced water vapor concentration) leaves condenser 140 and is directed to the blower 150. The cleaned waste gas stream is then conveyed at elevated pressure to a facility exhaust duct or equivalent for eventual release to ambient. The blower 150 is therefore operative to draw the waste gas stream through the various elements of treatment system 100 and to exhaust the waste gas stream from the system 100.

It will be recognized by those skilled in the art that, while the invention has been described above in terms of various aspects, it is not limited thereto. Various features and aspects of the above-described invention may be used individually or jointly. Further, although the invention has been described in the context of its implementation in a particular environment and for particular applications, e.g., semiconductor fabrication plants, those skilled in the art will recognize that its usefulness is not limited thereto and that the present invention can be beneficially utilized in any number of environments and implementations.

What is claimed is:

1. A waste gas treatment system, comprising:
a thermal oxidizer, for oxidizing selected gaseous species of a waste gas stream at an elevated temperature;
a cyclone scrubber coupled to an outlet of the thermal oxidizer, for removing at least a portion of the particulate matter and acid gases of the waste gas stream, the cyclone scrubber including a tube through which the waste gas stream flows and means for fully wetting the inner surface of the tube;
a packed bed scrubber containing a packing material and coupled to an outlet of the cyclone scrubber, for removing remaining particulates and acid gases of the waste gas stream; and
a means for drawing the waste gas stream through and from the waste gas treatment system.

2. The waste gas treatment system of claim 1, wherein the gas drawing means comprises a blower coupled to an outlet of the condenser.

3. The waste gas treatment system of claim 1, further comprising a condenser coupled to an outlet of the packed bed scrubber, for reducing a water vapor concentration of the waste gas stream.

4. The waste gas treatment system of claim 1, wherein the thermal oxidizer further comprises an oxidizing gas inlet for injecting a pressurized oxidizing gas stream into the waste gas stream for creating a turbulent mixture for greater combustion efficiency.

5. The waste gas treatment system of claim 1, wherein the thermal oxidizer further comprises a tube through which the waste gas stream passes.

6. The waste gas treatment system of claim 5, further comprising a means to heat the surface of the tube for oxidation of selected gaseous species of the waste gas stream.

7. The waste gas treatment system of claim 1, wherein the inside of the thermal oxidizer is lined with Nickel.

8. The waste gas treatment system of claim 1, wherein the packed column is a counter flow type packed column.

9. The waste gas treatment system of claim 1, wherein the packed column packing material is comprised of alumina ceramic.

10. The waste gas treatment system of claim 1, wherein the packed column packing material is comprised of stainless steel.

11. The waste gas treatment system of claim 1, wherein the packed column packing material is comprised of Teflon.

12. The waste gas treatment system of claim 1, wherein the packed column packing material is comprised of polypropylene.

13. The waste gas treatment system of claim 1, wherein the water supplied to the cyclone scrubber is recycled wastewater from the packed column.

14. A method of abating toxic gases and particulate matter from a waste gas stream in a treatment system, comprising the steps of:
introducing the gas stream into the treatment system;
oxidizing selected gaseous species in the gas stream at an elevated temperature to reduce the presence of combustible substances in the gas;
scrubbing the gas stream to reduce the presence of particulate matter and acid gases in the gas;
filtering the gas stream through a packed column to reduce the presence of acid gas species in the gas; and
expelling the gas stream to ambient and drawing the gas stream through the treatment system.

15. The method of claim 14, further comprising the step of condensing the gas stream to reduce the moisture content in the gas before the gas is expelled to ambient.

16. An apparatus for removing particulate matter and acid gases from a waste gas stream while inhibiting clogging and corrosion of a waste gas treatment system, the apparatus comprising:
a system inlet for the introduction of the waste gas stream;
a cooling section coupled to the system inlet, the cooling system including
a heat exchange means for cooling the waste gas and
a wetting means for reducing clogging and corrosion caused by particulate matter in the waste gas;
a scrubbing section coupled to the cooling section, for removing at least a portion of the particulate matter and acid gases of the waste gas stream; and
an outlet for discharging the treated waste gas.

17. The apparatus of claim 16, wherein the wetting means of the cooling section comprises:
an outer tube and an inner tube, wherein
the inner tube has a diameter less than that of the outer tube, and
the inner tube is located inside of and substantially concentric with the outer tube, forming an annulus between the inside surface of the outer tube and the outside surface of the inner tube; and
one or more cyclonic water inlet jets extending into the annulus through the outer tube, providing a cyclonic flow of water in the annulus around the inner tube, wherein the cyclonic water flow fills the annulus and cascades over the top of the inner tube wetting the inside and outside surfaces of the inner tube and the inside surface of the outer tube, wherein the wet surfaces of the inner and outer tubes inhibit adherence of the particulate matter in the waste gas to the inside surfaces of the tubes.

18. The apparatus of claim 16, wherein the heat exchange means of the cooling section comprises:
an outer tube and an inner tube, wherein
the inner tube has a diameter less than that of the outer tube, and
the inner tube is located inside of and substantially concentric with the outer tube, forming an annulus between the inside surface of the outer tube and the outside surface of the inner tube; and
one or more cyclonic water inlet jets extending into the annulus through the outer tube, providing a cyclonic flow of water in the annulus around the inner tube, wherein the cyclonic water flow fills the annulus and cascades over the top of the inner tube, wetting the inside and outside surfaces of the inner tube and the inside surface of the outer tube, wherein a heat exchange occurs between the waste gas stream and the water to reduce the temperature of the waste gas stream as it flows through the cooling section.

19. The apparatus of claim 16, wherein the scrubbing section further comprises:
one or more water atomizers extending into the scrubbing section for
establishing forced contact between pressurized water droplets and particulate matter in the waste stream, causing the particulates to adhere to the water, forming a water/particulate mixture, and
causing absorption of at least a portion of the acid gases of the waste gas stream into the water; and
a means for expulsion of the water/particulate mixture from the scrubbing section.

20. The apparatus of claim 19, wherein the water supplied to the water atomizers is fresh water.

21. The apparatus of claim 19 wherein the water supplied to the water atomizers is recycled wastewater.

22. A method of inhibiting clogging and corrosion of components in a waste gas treatment system, comprising the steps of:
providing an inner tube through which a waste gas stream flows;
providing an outer tube, wherein
the outer tube has a diameter greater than that of the inner tube, and
the inner tube is located inside of and substantially concentric with the outer tube, forming an annulus between the inside surface of the outer tube and the outside surface of the inner tube;
injecting a cyclonic water flow into the annulus, causing a wetting of the inside surface of the outer tube and the outside surface of the inner tube; and
filling the annulus until the water level cascades over the top of the inner tube, forming a film of water on the inside surface of the inner tube, inhibiting the adhesion of particulate matter from the waste gas stream to the inside surface of the inner tube, preventing clogging and corrosion of the tube.
